(19) United States
(12) Patent Application Publication
(10) Pub. No.: US 2003/0212796 A1
(43) Pub. Date: Nov. 13, 2003

(54) Loadable debit card system and method

(75) Inventor: Rick L. Willard, Las Vegas, NV (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Wow Technologies, Inc.

(21) Appl. No.: 10/374,737

(22) Filed: Feb. 24, 2003

Related U.S. Application Data
(60) Provisional application No. 60/359,320, filed on Feb. 23, 2002.
(60) Provisional application No. 60/367,624, filed on Mar. 25, 2002.
(60) Provisional application No. 60/375,493, filed on Apr. 25, 2002.

(51) Int. Cl. G06F 15/16

(52) U.S. Cl. 709/227

(57) ABSTRACT

The present invention allows a customer to load money in real-time through existing technology over the existing ATM/debit network by way of a debit return with a PIN (or debit correction/reversal using a specific transaction code). Money may then be loaded in real-time on an anonymous stored value/debit/ATM/multi-purpose/private transaction PIN-based card. Loading of money on a card or cards with or without the same account numbers is also provided for.

### CROSS-REFERENCES TO RELATED APPLICATIONS

This application claims the benefit of U.S. Provisional Patent Application No. 60/359,320, entitled LOADABLE DEBIT CARD SYSTEM AND METHOD, filed on Feb. 23, 2002, and U.S. Provisional Patent Application No. 60/367,624, entitled DEBIT CARD FEE DISTRIBUTION SYSTEM AND METHOD, FILED ON Mar. 25, 2002, and U.S. Provisional Patent Application No. 60/375,493 entitled INCREMENTAL NETWORK ACCESS PAYMENT SYSTEM AND METHOD UTILIZING DEBIT CARDS, filed on Apr. 25, 2002 which are hereby incorporated by reference.

### FIELD OF THE INVENTION

The present invention generally relates to debit cards and more particularly to a loadable debit card system using existing technology in a new manner.

### BACKGROUND OF THE INVENTION

Debit cards and gift cards are well known in the art. Such cards are typically linked to a user's bank account or are purchased from a vendor and come in fixed value increments, for example, $10, $20, and $50. A $10 card provides the customer with $10 of purchasing power utilizing an existing debit card system. However, current debit card and gift card technologies do not allow for a customer to load their debit cards with existing point-of-sale terminals. For example, prior art technology does not allow a customer to use an existing point-of-sale terminal to recharge their gift card and/or debit card without replacing it with a specialized terminal. In the operation of prior art systems, cards are batch activated by the card provider in a limited number of predetermined values. A customer purchases one of these pre-activated cards by paying a fee. The cards typically include a predetermined identification code. predetermined values. A customer purchases one of these pre-activated cards by paying a fee. The cards typically include a predetermined identification code.

Such systems have proved commercially successful and desirable for a number of reasons. Gift cards allow customers to present recipients of gifts with a convenient and easy to use payment mechanism. However, once the card has been used by the recipient, its usefulness is exhausted, and it is generally thrown away.

Accordingly, there is a need for an improved debit card that overcomes the limitation of prior art systems that may require specialized equipment and are not rechargeable with existing POS equipment, and do not allow for anonymous statement retrieval.

Gift card systems have proved marginally successful and desirable for a number of reasons. Gift cards allow customers to present recipients of gifts with a convenient and easy to use payment mechanism. However, many merchants have little or no incentive to sell cards, and neither to other parties in the supply chain system. Current debit card and gift card technologies do not allow for distributing fees associated with these cards to a wide audience to create incentives to distribute the cards.

Accordingly, there is a need for an improved debit card that overcomes the limitation of prior art systems that fail to provide adequate incentives to retailers and network participants to distribute and sell private debit cards.

Additionally, previous private debit card systems did not allow for statement retrievals, and in particular did not relate to retrieval of statements in an anonymous manner.

Accordingly, there is a need for an improved debit card that overcomes the limitation of prior art systems that may require specialized equipment and are not rechargeable with existing POS equipment.

### SUMMARY OF THE INVENTION

The present invention allows a customer to load money in real-time through existing technology over the existing ATM/debit network by way of a debit return with a PIN (or debit correction/reversal using a specific transaction code). Money may then be loaded in real-time (e.g. in under 120 seconds) on an anonymous stored value/debit/ATM/multi-purpose/private transaction PIN-based card. Loading of money on a card or cards with or without the same account numbers is also provided for.

### DETAILED DESCRIPTION OF THE PREFERRED EMBODIMENT

Attached are figures illustrating embodiments of the present invention. Those of ordinary skill in the art will appreciate that other embodiments, including additional devices, or combinations of illustrated devices, may be added to or combined in the present invention without changing the spirit or scope of the present invention.

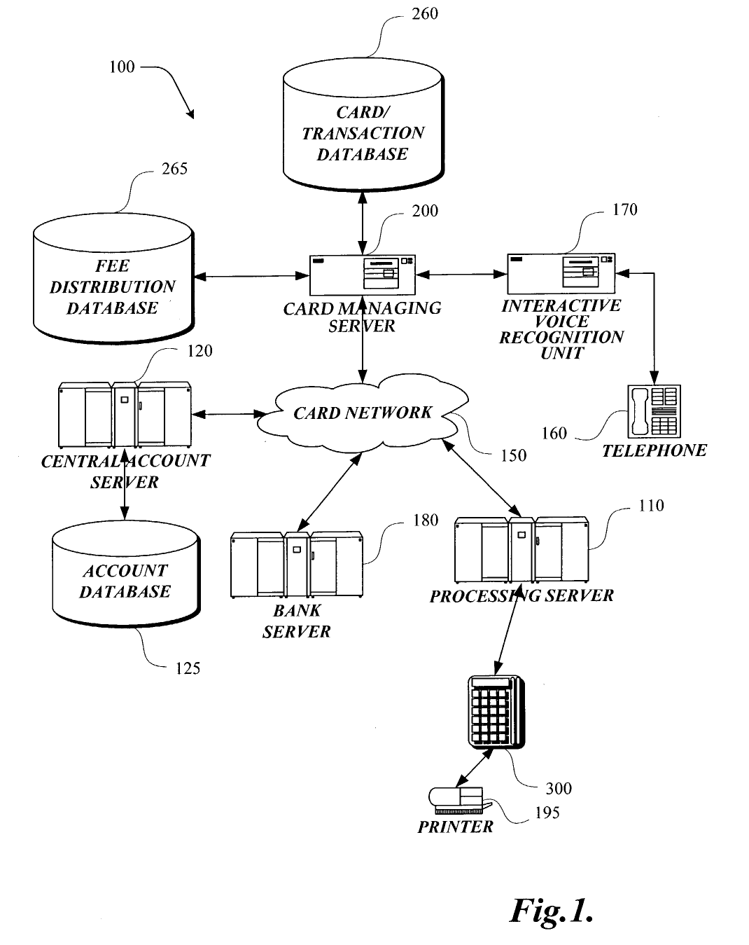

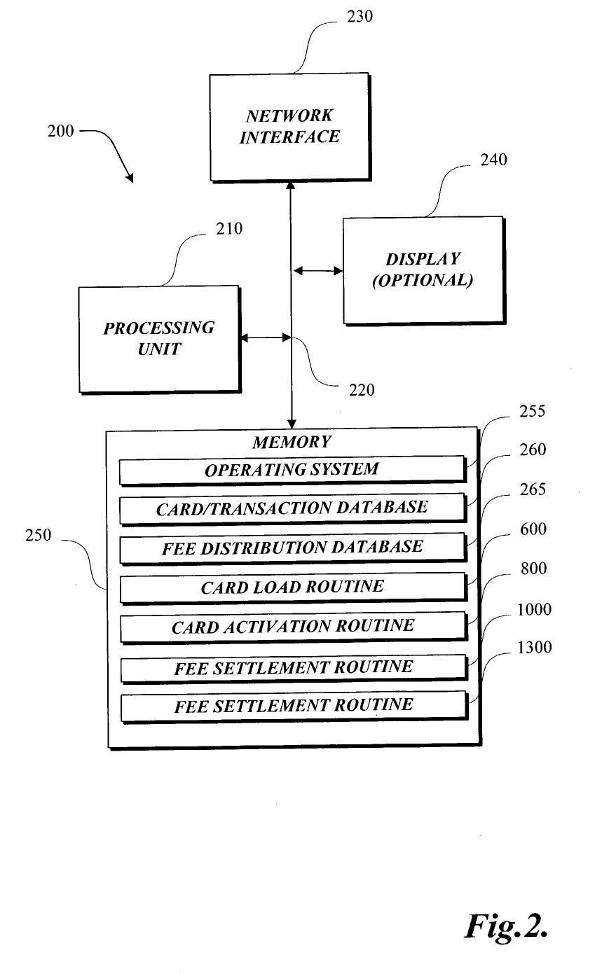

FIG. 1 illustrates an exemplary embodiment of a number of devices used in an exemplary embodiment of the present invention. FIG. 1 illustrates point-of-sale terminals 300 (optionally having a printer 195) connected to a processing server 110, which controls the interactions of the point-of-sale terminals 300 and a card network 150, such as a network provided by any of the well known debit/credit card transaction network providers (e.g., Star, Cirrus, Visa, MasterCard, American Express, Diners Club, etc.). Also in communication with the card network 150 is a central account server 120, having an account database 125 for managing individual card accounts. It will be appreciated by one of ordinary skill in the art that there may be a plurality of central account servers for managing account databases 125, or even that the role of the central account server 120 may be performed by another device such as bank server 180. Additionally, connected to the card network 150 is a card managing server 200, illustrated in FIG. 2 and described below. However, illustrated in FIG. 1 the card managing server 200 also includes a card/transaction database 260, which maintains information about individual cards and the transactions associated with them, and a fee distribution database 265 for determining how card fees will be distributed. It will be appreciated by those of ordinary skill in the art and others that the card/transaction database 260 and fee distribution database 265 may comprise a plurality of databases or may be a single database. Additionally, in communication with the card managing server 200 is an interactive voice recognition unit (“IVRU”) 170 connected to a telephone 160 for communication between a user and the card managing server 200. It will be appreciated by one of ordinary skill in the art that the telephone 160 may be connected to the IVRU 170 via any conventional telephone connection such as through a publicly-switched telephone network (not shown).

FIG. 2 illustrates several of the key components of the card managing server 200. Those of ordinary skill in the art will appreciate that the card managing server 200 may include many more components than those shown in FIG. 2. However, it is not necessary that all of these generally conventional components be shown in order to disclose an illustrative embodiment for practicing the present invention. As shown in FIG. 2, the card managing server 200 includes a network interface 230 for connecting to the card network 150. Those of ordinary skill in the art will appreciate that the network interface 230 includes the necessary circuitry for such a connection and is constructed for use with the appropriate protocol.

The card managing server 200 also includes a processing unit 200, may include an optional display 240, and a memory 250, all inter-collected along with the network interface 230 via a bus 220. The memory 250 generally comprises a random access memory (“RAM”), a read-only memory (“ROM”), and a permanent mass storage device, such as a disk drive. The memory 250 stores the program code necessary for a card real-time load routine 600, a card activation routine 800, a station at retrieval routine 1000 and a settlement routine 1200, in addition to the card/transaction database 260 and fee distribution database 265. In addition, the memory 250 also stores an operating system 255. It will be appreciated that these software components may be loaded from a computer-readable medium into memory 250 of the card managing server 200 using a drive mechanism (not shown) associated with a computer-readable medium, such a floppy disc, tape, or DVD/CD-ROM drive or via the network interface 230.

Although an exemplary card managing server 200 has been described that generally conforms to conventional general purpose computing device, those of ordinary skill in the art will appreciate that a card managing server may be any of a great number of devices capable of communicating with the card network 150 or with the interactive voice recognition unit 170.

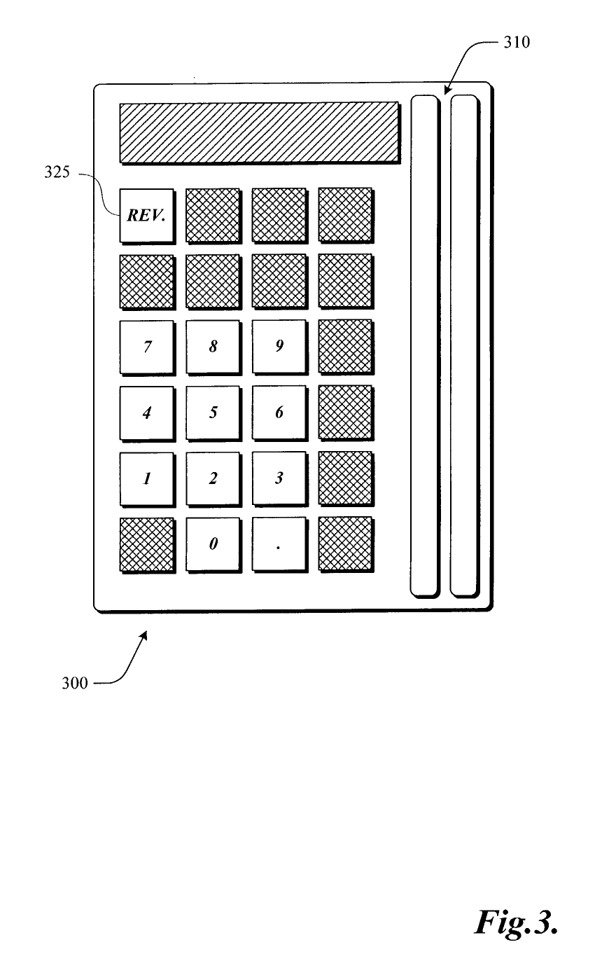

FIG. 3 depicts an exemplary point of sale (“POS”) device 300 for use in the present invention. The POS device 300 includes a card reader 310 and a reversal transaction button 325. Although an exemplary POS device 300 has been described and shown in FIG. 3, those of ordinary skill in the art will appreciate that POS devices may take many forms and may include many additional components other than those shown in FIG. 3. For example, the POS device 300 may include a connection to a printer 195 for printing information received at the POS device 300.

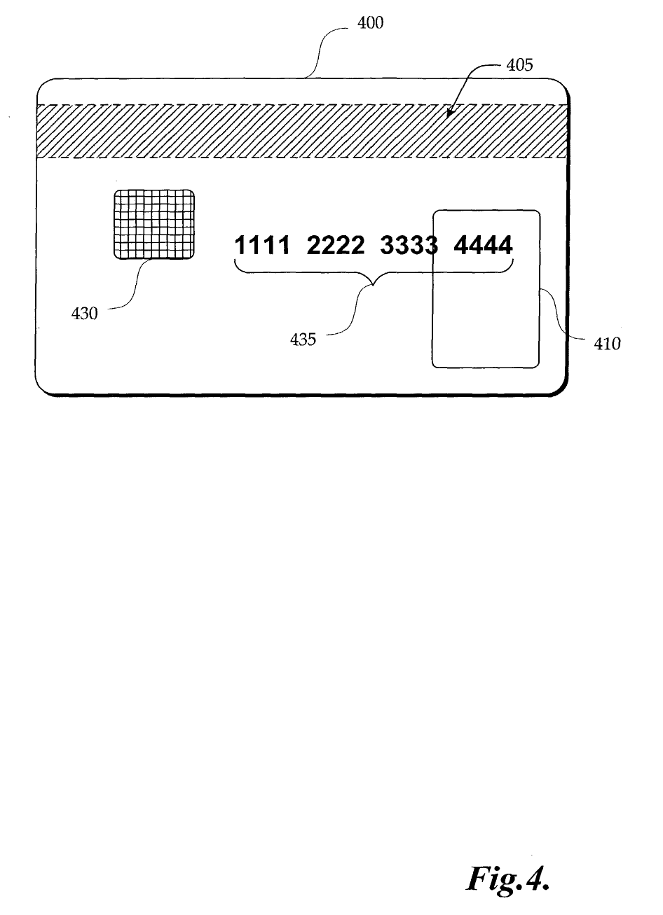

FIG. 4 illustrates an exemplary card 400, such as a loadable debit card in accordance with the present invention. The card 400 may include a magnetic strip 405, a smart card chip interface 430, embossed account numbers 435 and/or fraud prevention components 410 (e.g., decals, photographs, holograms, etc.). It will be appreciated by those of ordinary skill in the art that the card 400 may include any of the magnetic strip 405, smart card chip interface 430, and embossed numbers 435 to be effective as a loadable debit card. It will further be appreciated that additional means of storing information or providing information on the card may also be used. In one exemplary embodiment, a security code may be printed or embossed on the card 400 as well.

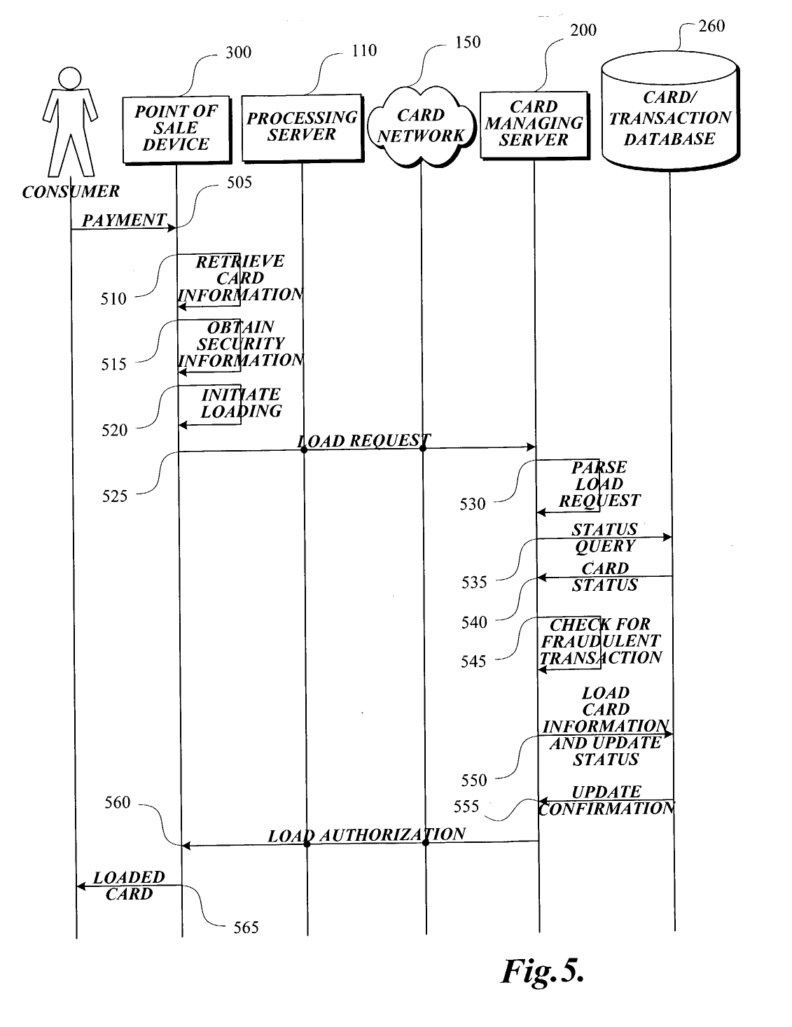

FIG. 5 illustrates steps taken to load a value in real-time onto the loadable debit card 400 in accordance with the present invention. A consumer provides payment 505 to a merchant with a POS device 300. The merchant using the POS device 300 will then retrieve a card and retrieve card information 510 (e.g., an account number) from the card 400. Next, a where merchant security information is obtained 515 is performed, either by the merchant, automatically by the POS device 300 or a combination of both. In one exemplary embodiment the merchant enters a merchant PIN and the POS device 300 has a POS identification number that are both used as security information. After the security information is obtained 515, then the merchant initiates a loading transaction 520 (real time debit return with a pin, debit correction, or debit reversal with transaction code) at their POS device 300. Loading transactions of the present invention are those transactions that normally take place when a refund is being issued to an existing debit card. However, in prior art systems, these transactions were unavailable for loading gift cards or private debit cards such as card 400. Prior art systems would reject such transaction at the card network level. In accordance with the present invention, the merchant with the POS device 300 has activated the POS device 300 in such a way with the card network 150 as to allow loading transactions to be initiated for loading values onto debit cards in accordance with the present invention. In one exemplary embodiment, the activation of the POS device 300 includes obtaining approval from a card network provider to allow such transactions. The load request (of a designated amount) from the POS device 300 is then communicated to a processing server 110, which forwards it via the card network 150 to the card managing server 200. Once the card managing server 200 receives the load request 525, it is parsed 530 to determine the card information, the POS and processors' information, and the amount of the transaction. A status query 535 is sent to the card/transaction database 260 to determine the current status of the card and its associated account and the current status is then returned 540 to the card managing server 200. Next, the transaction is checked for any fraudulent activity 545 or errors in the transaction. The security information gathered at the POS device 300 is checked, along with the account number of the card 400 to ascertain that the transaction is a legitimate loading transaction. Those of ordinary skill in the art and others will appreciate that a variety of security verification checks may be implemented with such information. Assuming no fraud or errors are present in the transaction, then the card information is loaded 550 to a card/transaction database 260. Once the card information has been loaded and updated at the card/transaction database 260, then the card managing server 200 receives an update confirmation 555 from the card/transaction database 260. The card managing server 200 then sends a load authorization 560 back via the card network 150 and the processing server 110 to the POS device 300. Once the merchant receives the authorization at their POS device 300, they may then provide 565 the card 400 to the consumer as a loaded card.

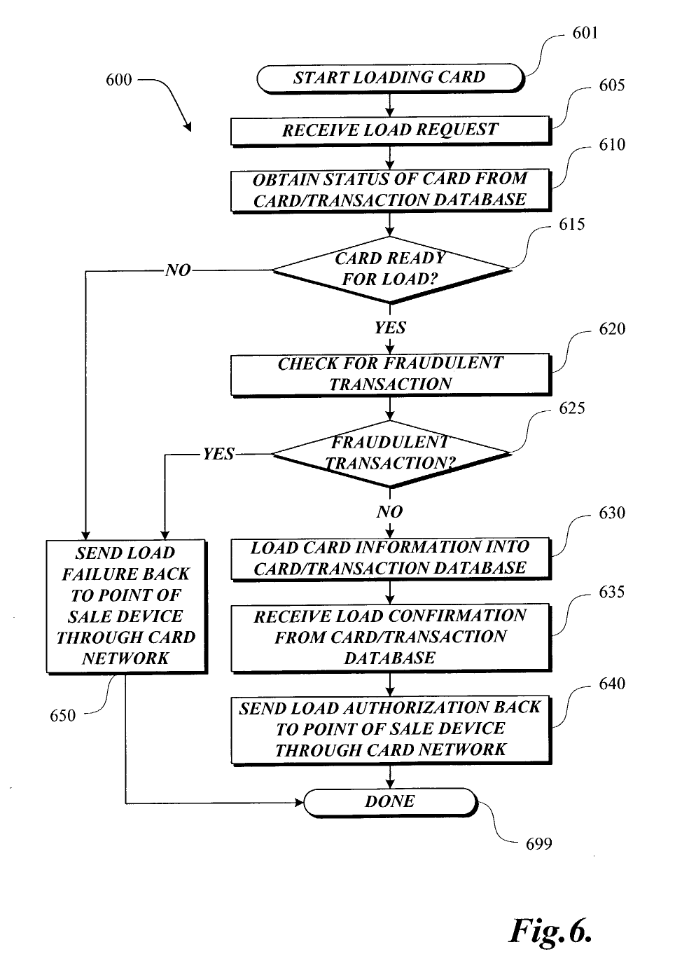

FIG. 6 illustrates an exemplary card loading routine from the view of the card managing server 200. The card loading routine beings in block 601 and proceeds to block 605 where it receives a load request. Next, in block 610, the status of the card is obtained from the card/transaction database 260. Next, in decision block 615, a determination is made whether the status of the card with the card/transaction database 260 indicates that the card is ready for loading. If it was found in decision block 615 that the card was not ready for loading, then a load error is sent back to the POS device 300 through the card network 150 in block 650 and processing ends at block 699. Otherwise, if in decision block 615 a determination is made that the card was ready for loading, then, in block 620, the card managing server 200 checks for fraudulent transactions or errors in the transaction. Security information included in the load request (e.g., merchant PIN and POS device 300 identification) is checked, along with the account number of the card 400, to ascertain that the transaction is a legitimate loading transaction. Those of ordinary skill in the art and others will appreciate that a variety of security verification checks may be implemented with such information. Next, in decision block 625, a determination is made whether any errors or fraudulent aspects were found in the transaction and, if they were found, then processing continues to block 650. Otherwise, if no errors or fraudulent indications were found for the transaction, then, in block 630, the card information, along with the information in the load request (e.g., load amount, processor information, and point of sale information), is loaded into the card/transaction database 260. Then, in block 635, the card managing server 200 receives a confirmation that the card information has been loaded and updated in the card/transaction database. Once the load has been confirmed, then, in block 640, the card managing server sends the load authorization back to the POS device 300 via the card network 150 and the processing server 100. Routine 600 then ends at block 699.

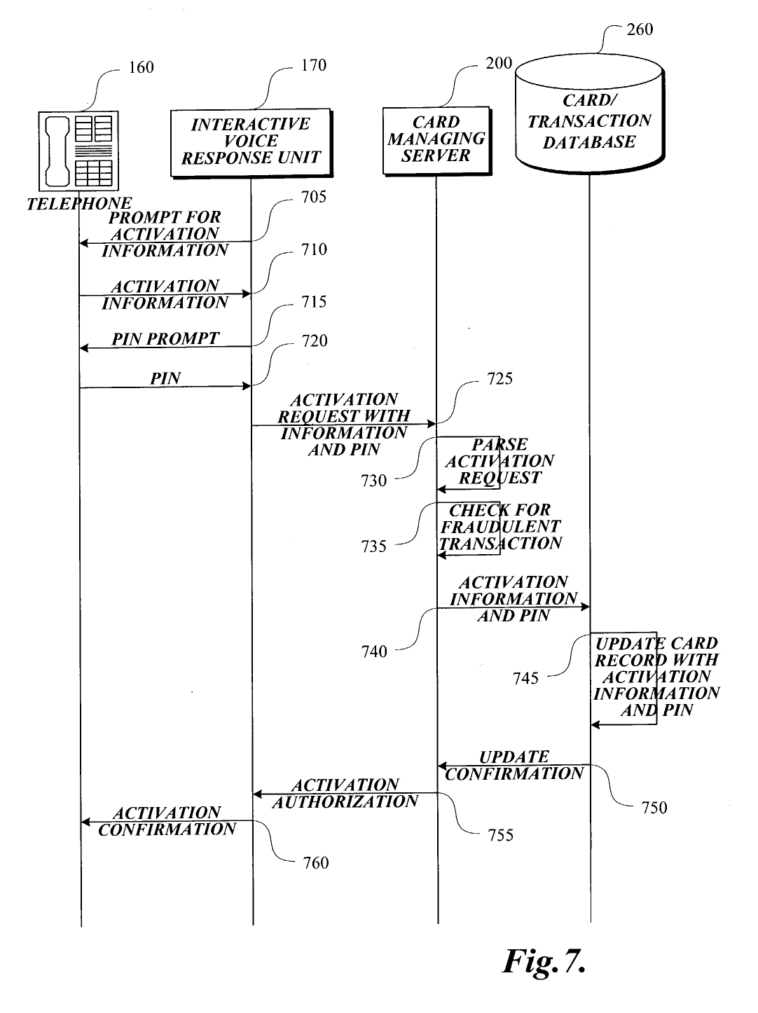

To better illustrate the operation of activating the loaded debit card of the present invention, FIG. 7 illustrates one exemplary embodiment of the actions performed by a system for activating the loadable debit card. The system of FIG. 7 includes a telephone 160 and interactive voice response unit 170, a card managing server 200 and a card/transaction database 260. Upon connection with the interactive voice response unit 170, the telephone 160 receives a prompt 705 for activation information. The customer enters activation information 710 (e.g., account number, security code and possibly other optional registration information, such as a customer name and contact information) into the telephone 160 via voice, rotary, touch tones or other technology known to those of ordinary skill in the art. Upon receipt of the activation information the interactive voice response unit 170 then requests 715 a personal identification number (“PIN”). The customer may then enter a PIN 720 via voice, rotary, touch tones or other means using the telephone 160. Once the IVRU 170 has received the PIN it forwards an activation request 725 with the activation information and PIN to the card managing server 200. The card managing server parses 730 the activation requests to extract the relevant card information and PIN number and checks for any fraudulent transactions 735 or errors in the activation request (e.g., by determining if an initial transaction was performed to load value onto the card 400). Assuming that no fraud or errors were found then the activation information and PIN is forwarded 740 to the card/transaction database 260 where the appropriate card record is updated 745 with the activation information and PIN and marked as activated. The update is confirmed 750 back to the card managing server 200 which then sends the activation authorization 755 to the interactive voice response unit 170. The interactive voice response unit 170 may then send activation confirmation 760 to the customer via the telephone 160 either contemporaneously with the activation requests or at a later point. It will be appreciated by those of ordinary skill in the art that other activation methods may also be employed such as via messaging systems and/or data communications over a network. Such alternate systems would operate in a similar manner, but substitute alternate communication devices instead of a telephone 160 and IVRU 170.

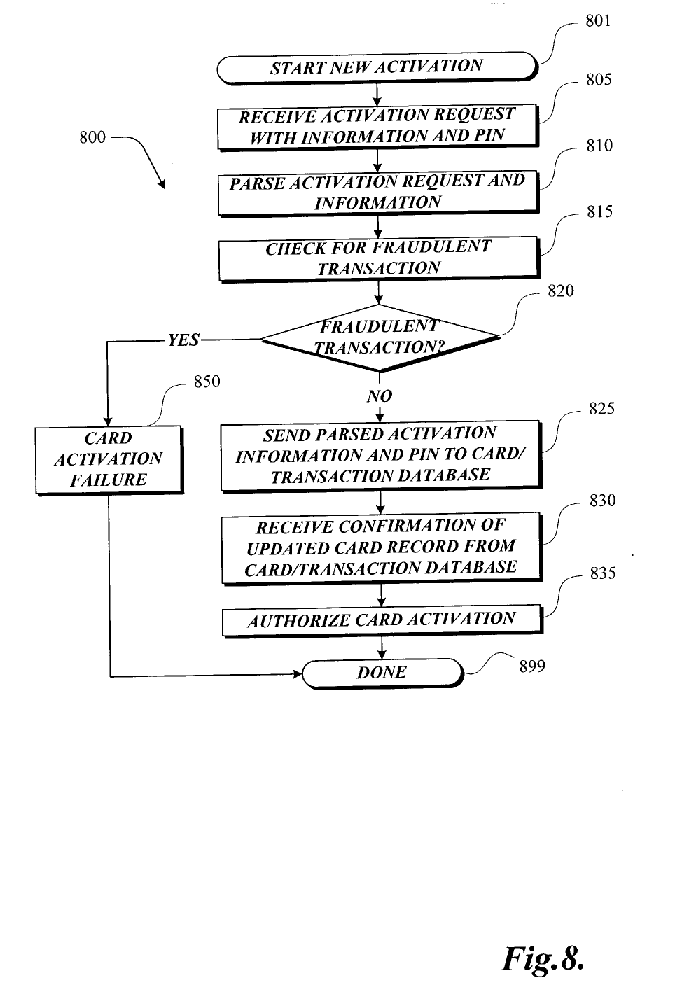

A flow chart illustrating an exemplary activation routine 800 implemented by the card managing server 200 is shown in FIG. 8. The activation routine 800 begins at block 801 and proceeds to block 805 where an activation request is received with activation information and a PIN. Next, in block 810 the activation request is parsed to retrieve relevant information including the activation information and the PIN. The activation information may include any form of information that would be appropriate for activating the loadable debit card. Such as the numbers embossed on the front of the card with an additional set of numbers (e.g., a security code) that may be provided separately or printed in alternate placement on the card such as on the reverse side of the card. Additionally, the PIN information will be selectable by the consumer or in one alternate embodiment may be assigned at the time of loading by a merchant and provided to the consumer as a further means of authentication during activation. The flow of routine 800 continues to block 815 where the activation transaction is checked for any fraudulent or flawed components. If now flaws, errors or fraudulent indicators were found in decision block 820 then processing continues to block 825. Otherwise, if a flaw error or fraudulent indicator was found then in block 850 a card activation failure is sent out by the card managing server 200 and routine 800 ends at block 899. Back in block 825 the card managing server 200 sends the parsed activation information and PIN to the card/transaction database 260. Next, in block 830 the card/transaction database 260 sends back a confirmation of the updated card record which is received by the card managing server 200. Routine 800 then continues to block 835 where the card activation is authorized and routine 800 then ends at block 899.

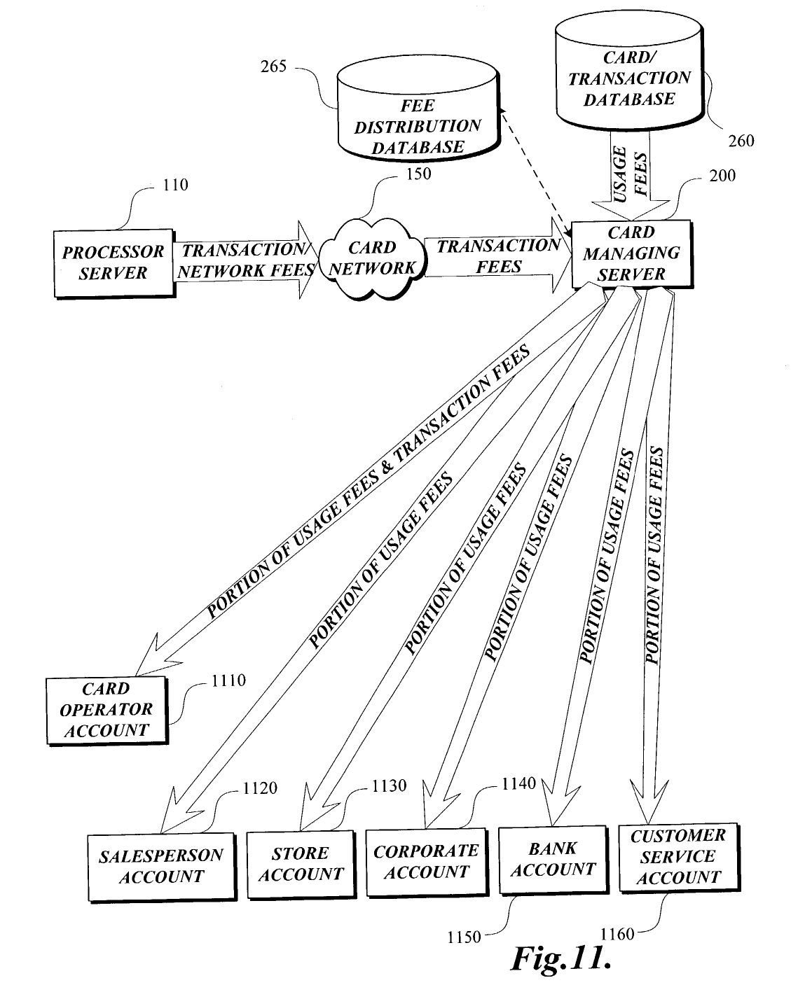

In the past, debit cards only had transaction fees associated with the use of the card and their associated account may have had banking fees that were unrelated to the use of the card (i.e., the banking fees would have been charged regardless of whether the card had a balance, was present, used, or not used). These previous transaction fees typically only benefited either a merchant or a bank, or in the case of an ATM machine, the ATM's bank or ATM's operator. Accordingly, debit cards were typically only used in the past by banking institutions that could collect these collateral transaction fees. Some merchants did issue their own debit “gift” cards, however, these usually were limited to use within a particular merchant's store or stores. As all the transaction fees and/or costs associated with the card went to the merchant, there was no incentive for other merchants or banks to recognize these cards. However, the card system of the present invention does not merely limit the incentives to transaction fees associated with the card, rather there is a card account fee that is charged to the cardholder so long as they carry a balance on the card. In one exemplary embodiment this is a $0.25 per day charge, such that on any given day that there is a balance on the card up to $0.25 is deducted per day from that card account. If the balance is less than $0.25 on any given day, then the card account has the total balance deducted and then thereafter has no account fees taken from the card account until there is a balance again on the card account. Using such a $0.25 per day fee equates to approximately $7.50 a month, not dissimilar from conventional banking charges for standard accounts. However, unlike convention bank accounts the fees collected from the card are distributed to a number of different entities in accordance with the present invention. FIG. 11 below illustrates one exemplary breakdown of the fee distribution system, however, those of ordinary skill in the art will appreciate that any number of fee distribution systems may be utilized either with more or less entities receiving fees as appropriate under market conditions.

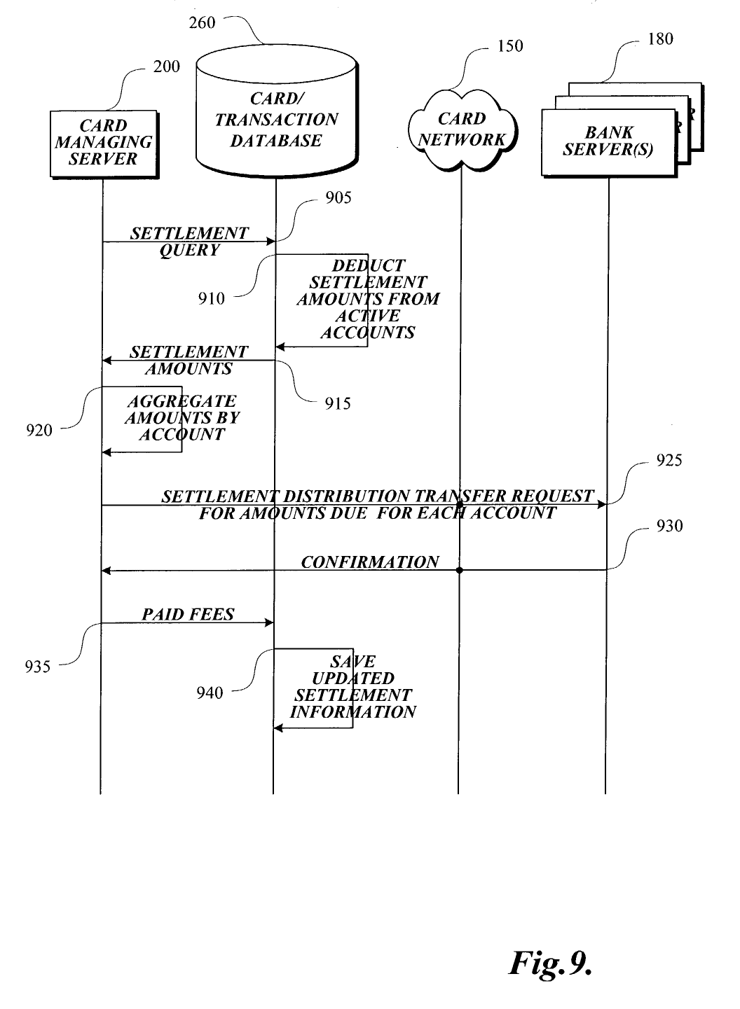

In addition to loading and activating the loadable debt card 400, the present invention allows for the settling of transactions and the distribution of fees associated with the use of the loadable debit card 400. To better illustrate the settlement operations, FIG. 9 illustrates one exemplary embodiment of actions performed by a system for settling transactions. The system of FIG. 9 includes the card managing server 200, the card/transaction database 260, the card network 150 and bank server or servers 180. The settlements are periodically performed and are initiated when the card managing server 200 sends a settlement query 905 to the card transaction database 260 to determine which transactions and fees are ready for settlement. This may occur at regular time intervals, or in one embodiment when sufficient transactions have reached a level where the settlement transaction will be of a predetermined size (e.g., if at least $100,000 in fees will be distributed). In another embodiment settlement queries 905 may happen more often, but only accounts receiving over a predetermined amount are used for queries. For example, if the account only is due $0.10, then it is not reported until the amount due reaches some threshold, such as $10. The settlement amounts are deducted from active accounts identified at the card/transaction database 260. The card transaction database 260 returns 915 a listing of the settlement amounts which are ready of settlement. The card managing server 200 then aggregates 920 settlement amounts for the payment transactions received from the card transaction database 260 and the fees for balances on cards, and aggregates the payments and fees by account as provided in the fee distribution database 265 (not shown in FIG. 9). The aggregated payments and fees are then forwarded 925 via the card network 150 to a bank server 180 for transfers to the appropriate accounts. It will be appreciated by one of ordinary skill in the art and others that these payments may be sent to a bank server 180 if the bank server 180 is managing the accounts. If there is a plurality of different institutions managing the accounts for which payments and fees are to be sent then in another embodiment the central account server 120 may receive the settlement transfer requests and then forward them to different banking servers as determined from its account database 125. However, in one exemplary embodiment illustrated in FIG. 9, a single bank server 180 is used. Once the settlement transfer requests have been received and processed by the bank server 180 a confirmation 930 is returned via the card network 150 to the card managing server 200. The card managing server 200 then sends 935 the list of completed settlement transactions back to the card/transaction database 260 where the updated settlement information is saved 940.

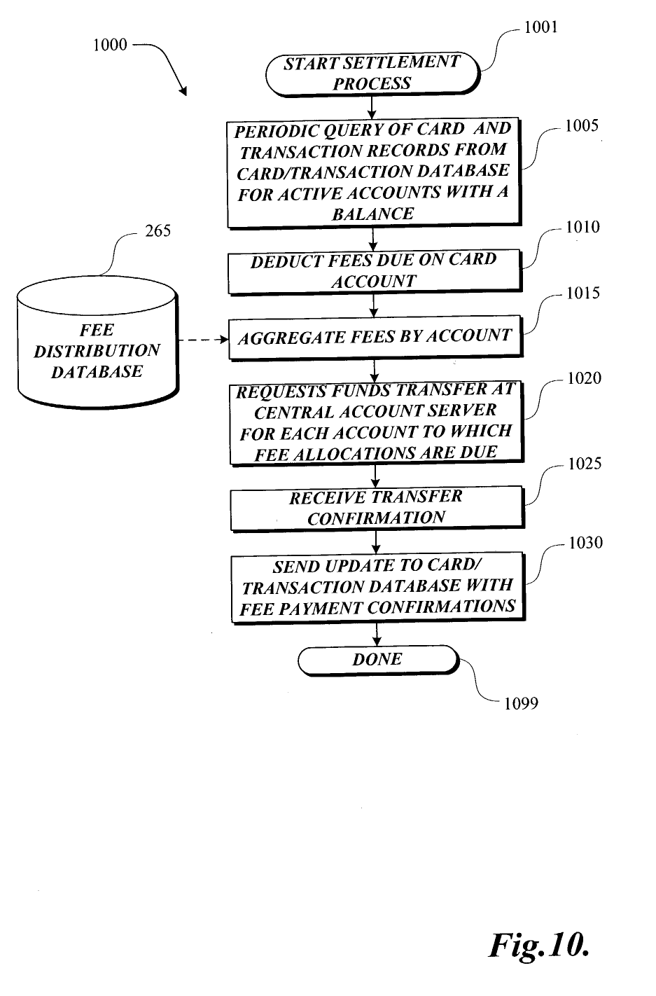

Much as illustrated in FIG. 9, FIG. 10 illustrates the settlement process from the point of view of the card managing server 200. Settlement routine 1000 starts at block 1001 and proceeds to block 1005 where the transaction records for the periodic settlement are retrieved from the card/transaction database 260. Next, in block 1010 the fees due on payment transactions and payments due to particular accounts are determined. Then, in block 1015 the payment and fees are aggregated by account (assisted by the fee distribution database 265) to minimize the number of transactions requested from the server in charge of accounts. In block 1020 the funds transfer request is sent for all the accounts for which funds are due, including payments and fees. Block 1020 may send the funds transfer request either to a bank server 180 or the funds transfer requests may be send to a central account server which will manage the transfers to a plurality of banking servers. The funds transfer requests are confirmed upon completion which is received in block 1025. Next, in block 1030 the card managing server 200 sends an update to the card/transaction database 260 indicating that all the completed transactions were received from the confirmation in block 1025. Routine 1000 then ends at block 1099.

FIG. 11 illustrates one exemplary fee distribution system illustrating the collecting and distribution of fees in accordance with the present invention. For purposes of simplicity, only two types of fees are illustrated in FIG. 11, usage fees and transaction fees. The transaction fees are those fees that are associated with debit card transactions in a conventional debit card network, such as merchant fees, card network fees, and/or banking fees. For example, if a consumer were to pay for $10 of gasoline at a gas station with a surcharge for using debit cards, there would be a $0.25 surcharge which goes to the gas station, e.g., the merchant, which is collected at their process server 110. Next, there would be a card network fee which is usually a fixed amount plus a percent of a transaction, in this case perhaps $0.10 plus 2% of the transaction, which is another $0.30 and that $0.30 is distributed between the card network and the banking institution or institutions involved according to conventional mechanisms in the debit card system. So, accordingly, in FIG. 11 we see a process server 110 sending transaction and network fees to a card network 150. The card network “absorbs” the network fees and passes on any remaining transaction fees to the card institution in this invention, represented by the card managing server 200. The card managing server than sends those transaction fees to a card operator account 1110. However, in addition to the conventional transaction fees associated with a debit card, there are the usage fees which in one embodiment of the invention is $0.25 per day that a card carries a balance. Accordingly, once a day a query is run on the card transaction database 260 and the usage fees are calculated and sent to the card managing server 200, which then distributes a portion of the usage fees to various accountholders. In one exemplary embodiment shown in FIG. 11 a portion of the usage fees goes to the card account 1110, a salesperson account 1120, a store account 1130, a corporate account 1140, a bank's account 1150, and customer service account 1160. Those of ordinary skill in the art will appreciate that although the singular is used when describing accounts that the plural applies as well in that there may be a multitude a salesperson accounts 1120, store accounts 1130, corporate accounts 1140, banks' accounts 1150, and customer service accounts 1160. However, it is generally anticipated that there will be a smaller number of card operator accounts 1110, possibly even only a single card operator account 1110.

In one exemplary embodiment the $0.25 fee is distributed proportionately as follows: The salesperson/people get $0.03 to the salesperson account 1120, the merchant gets $0.05 to the store account 1130, the corporation owning the store gets $0.03 to the corporate account 1140, the bank gets $0.01 to the bank's account 1150 and the customer service center gets $0.01 for the customer service account 1160. The remaining $0.12 goes to the card operator account 1110. Other distributions and parties may be used in other embodiments. For example, if the company owning the merchant's store has over one million cards, they may get a higher share (perhaps $0.05).

While the distribution of the usage fees is shown as going to a particular account, the card managing server utilizes the fee distribution database 265 to determine exactly which accounts will receive which portion of the usage fees. After which, the share going to that account is transferred using convention banking systems such as the automated clearinghouse (“ACH”) transfer system to transfer the fees to the appropriate account. Such conventional banking systems usually have a cost associated with such a transfer which is deducted from the amount transferred to the account on a per transfer basis in one embodiment of the present invention.

In another exemplary embodiment of the present invention, certain accounts may elect to receive their transfers on a less frequent basis. Accordingly, the card managing server may view the accountholders' record in the fee distribution database and only initiate a transfer once conditions have been met. In an exemplary embodiment, the condition may be that transfers occur monthly. In another exemplary embodiment, the transfers may only be initiated once a certain threshold of fees, such as $10, $20, $100, have been aggregated as payable to the accountholder. Those of ordinary skill in the art will appreciate that many combinations and variations of the fee distribution system described above may be made without departing from the spirit and scope of this invention.

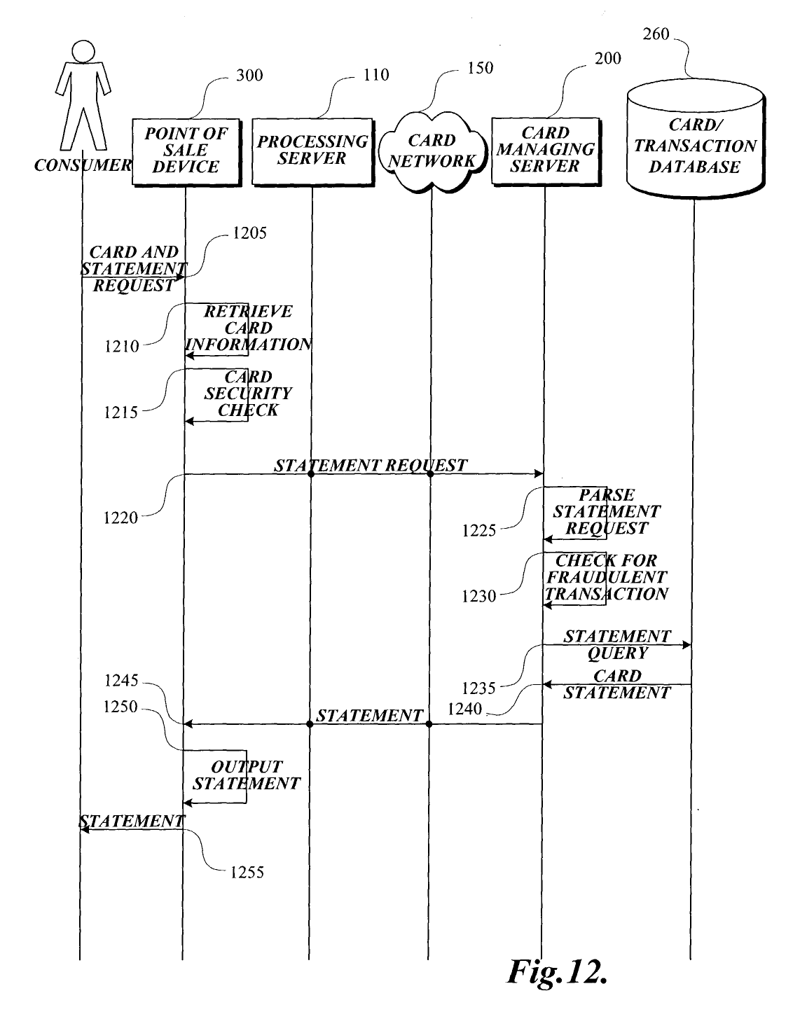

In addition to providing benefits to merchants and operators, the present invention provides additional benefits to consumers. For example, the present invention allows consumers to retrieve account statements in an efficient and anonymous manner. FIG. 12 illustrates steps taken to retrieve a statement for the loadable debit card 400. A consumer requests a statement 1205 from a POS device 300 (or an ATM). The POS device retrieves 1210 card information from the card 400. Next, a card security check 1215 is performed by the POS device 300. Once it is determined that the card 400 is a valid card and has passed the security check, the POS device initiates a statement request 1220 that is communicated to a processing server 110, which forwards it via the card network 150 to the card managing server 200. Once the card managing server 200 receives the statement request, it is parsed 1225 to determine the card information. Next, the transaction is checked for any fraudulent activity 1230 or errors in the transaction. Assuming no fraud or errors are present in the transaction, then the statement query 1235 is sent to card/transaction database 260. The card/transaction database 260 then sends the current statement 1240 to the card managing server 200. The card managing server 200 then sends the statement 1245 back via the card network 150 and the processing server 110 to the POS device 300. Once the POS device 300 outputs 1250 the statement (either at a display or optionally at a printer 195), the consumer may then retrieve 1255 their statement. In an alternate embodiment the POS device 300 is supplanted by an Automated Teller Machine (“ATM”) that prints the statement and outputs the statement from an internal printer (not shown).

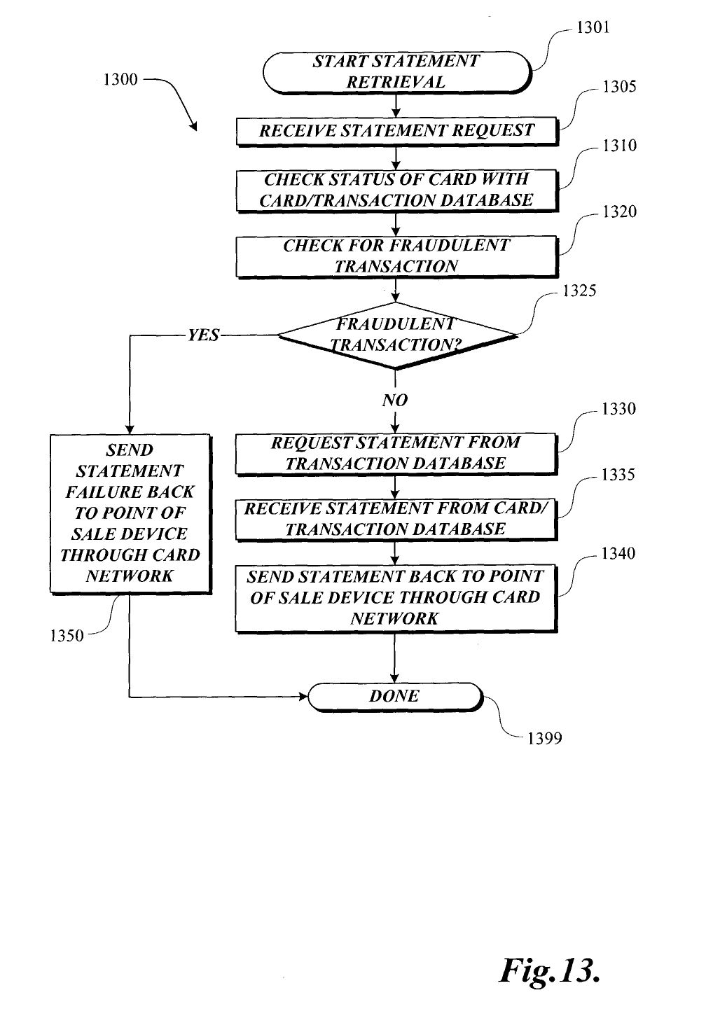

FIG. 13 illustrates an exemplary statement retrieval routine from the view of the card managing server 200. The statement retrieval routine beings in block 1301 and proceeds to block 1305 where it receives a statement request. Next, in block 1310, the status of the card is checked with the card/transaction database 260. Next, in decision block 1315, a determination is made whether the check of the status of the card with the card/transaction database 260 indicates that the card is ready for loading. Then, in block 1320, the card managing server 200 checks for fraudulent transactions or errors in the transaction. Next, in decision block 1325, a determination is made whether any errors or fraudulent aspects were found in the transaction and, if they were found, then processing continues to block 1350 where an error is sent back to the POS device through the card network and processing ends at block 1399. Otherwise, if no errors or fraudulent indications were found for the transaction, then, in block 1330, the a statement request is sent to the card/transaction database 260. Then, in block 1335, the card managing server 200 receives the card statement from the card/transaction database 260. Then, in block 1340, the card managing server sends the statement back to the POS device 300 via the card network 150 and the processing server 110. Routine 1300 then ends at block 1399.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer implemented method of real-time anonymous loading and activating a loadable debit card account, the method comprising:
obtaining a card load request comprising merchant security information, a loadable debit card account identifier and a load amount from a point of sale device;
verifying said merchant security information at a card managing server;
if said merchant security information is verified, updating the loadable debit card account with said load amount;
after updating the loadable debit card account, obtaining an activation request comprising activation information and a new card PIN;
verifying said activation information; and
if said activation information is verified, activating the loadable debit card account.

2. The method of claim 1 wherein said merchant security information comprises a point of sale device identifier.

3. The method of claim 1 wherein said merchant security information comprises a merchant PIN.

4. The method of claim 1 wherein said activation information comprises a security code.

5. The method of claim 1 wherein said activation information is verified by matching said security code with a security code corresponding to said loadable debit card account.

6. The method of claim 1 wherein said activation information comprises a consumer identifying information.

7. The method of claim 1 wherein said activation information is obtained from an interactive voice recognition unit.

8. A computer readable medium containing computer executable instructions for performing the method of any of claims 1 to 7.

9. A computing apparatus having a processor and a memory having computer executable instructions for performing the method of any of claims 1 to 7.
